(19) United States
(12) Patent Application Publication
(10) Pub. No.: US 2010/0307040 A1
(43) Pub. Date: Dec. 9, 2010

(54) Illumination of an electric fire

(76) Inventor: Noel O'Neill, Drogheda (IE)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 12/308,616

(22) PCT Filed: Jun. 22, 2007
(86) PCT No.: PCT/EP2007/056243

§ 371 Date: Dec. 19, 2008

(30) Foreign Application Priority Data
Jun. 22, 2006 (GB) 0612387.1

(51) Int. Cl. F21S 10/04

(52) U.S. Cl. 40/428

(57) ABSTRACT

An electric fire is described which includes a flame simulation arrangement configured to simulate the effect of burning flames. The fire includes a lighting arrangement provided behind and parallel to the flame simulation arrangement and configured to backlight the simulated flames.

### FIELD OF THE INVENTION

The present invention relates to electric fires and in particular to an electric fire with improved internal illumination.

### BACKGROUND

Electric fires are well known in the art and are used to simulate the effects of a real coal or wood fire. Although developments have been made in certain areas of the fire, such as those described in our earlier British Patent, GB 2180927, the simplest of electric fires include housing having a heating element, a light source used to illuminate an artificial fuel bed and a reflective screen that is upstanding from the fuel bed and is used to simulate flame effects.

Problems associated with such fires include the fact that the flame effect achievable is not convincing. Furthermore the lighting that is achieved within the housing is not particularly bright which makes it hard, in areas of high brightness such as on a shop floor at the time of sale, for a potential purchaser to ascertain whether there is a light provided or not.

There is therefore a need to provide an improved fire.

### SUMMARY

These and other problems are addressed by a fire in accordance with the teaching of the present invention which provides for a more complete illumination within the housing than heretofore achievable. A fire provided in accordance with the teachings of the invention is configured to provide a backlight that has an extended area of illumination that may be used to directly illuminate internal portions and elements of the fire. The lighting arrangement is provided to backlight a flame effect simulation arrangement and is substantially parallel with that arrangement.

Accordingly the invention provides a fire according to claim 1. Advantageous embodiments are provided in the dependent claim. The invention also provides a fire substantially as hereinafter described with reference to the accompanying drawings.

These and other features of the invention will be better understood with reference to the following drawings which are provided to illustrate exemplary embodiments of the invention.

### BRIEF DESCRIPTION OF THE DRAWINGS

The present invention will now be described with reference to the accompanying drawings in which:

FIG. 1 is an exploded view of portion of a disassembled fire in accordance with the teaching of the invention.

FIG. 2 is an exploded view showing how the assembled portion of FIG. 1 can be combined with other elements to define a complete fire.

FIG. 3 is a sectional view through an assembled fire.

FIG. 4 is a sectional view through a different embodiment of an assembled fire.

### DETAILED DESCRIPTION OF THE DRAWINGS

The invention will now be described with reference to preferred embodiments thereof which are provided as illustrative of the teaching of the invention and are not to be construed in any way limiting.

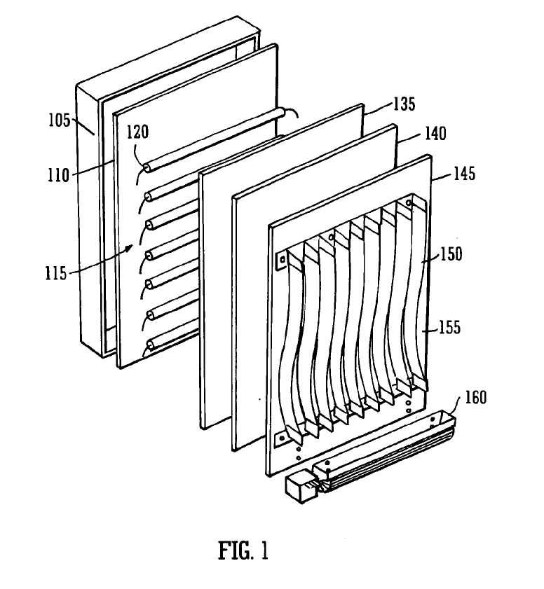

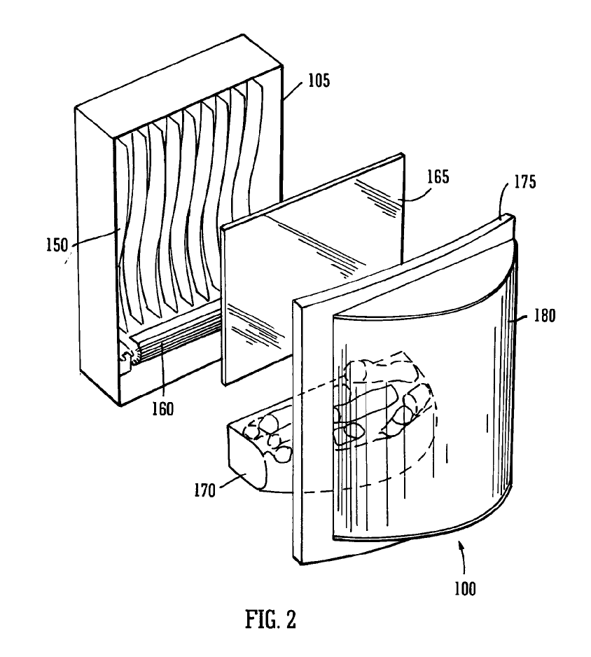

As shown in FIGS. 1 and 2, a fire 100 in accordance with the teaching of the invention includes a plurality of parts or components. In this exemplary embodiment a rear casing 105 is provided within which a number of components may be mounted. For example a rear reflector 110 which may be completely or partially mirrored or even for example be provided as a material with enhanced specular reflectivity is provided to project light forwardly of the casing towards the front of the fire. Such provision of a rear reflector is advantageous where maximised light output is required. In front of the rear reflector a lighting arrangement 115 is provided which is configured to generate a wall of light, effectively a distributed light source vertically-orientated within the housing. Such an arrangement defines an extended light source, with the wall of light having a height and length greater than its thickness and is desirably upstanding from a base portion of the fire. In this embodiment the wall of light is formed by sandwiching a plurality of cold cathode fluorescent lamps (CCFLs) 120 which are mounted one above the other between the rear reflector and a front screen 135 which may provided to provide for an enhancement of the brightness created by the tubes. The screen may be fabricated as a film from material such as that provided by 3M under the brand name Vikuti™. Such a material comprises a plurality of randomly arranged prisms and is known in the trade as a prism sheet. The purpose of such sheets is to recycle light output until the light emits from a viewing cone defined within the prism. When provided, such a brightness enhancement film may be used to increase the light level that would be seen from the front of the fire and reduce light leakage to other areas such as for example the side or base of the fire. It will be understood that such a film is an optional component of the fire.

The number and orientation of the individual lamps 120 is not important as it will be appreciated by those skilled in the art that the specific geometry will not affect the overall luminosity that is generated across this wide area defined by the wall of light. In this way, it will be appreciated that as few as 1 lamp, if provided of sufficient geometric dimension may be suitable. However it is expected that a plurality of lamps will be provided, and the individual lamps will be distributed within the plane defined by wall so as to effectively provide a distributed light source defining a substantial portion of the entire rear plane of the fire. In this way the tubes could be straight or for example U-shaped and could be mounted as a plurality of sources one above the other (as shown) or indeed side by side. It is also possible to replace the CCFL lamps with other suitable light sources for example, LED's or indeed to use an electroluminescent (EL) screen as the wall of light. In this context it will be appreciated that any light source such as incandescent lamps, tungsten halogen etc. etc. may be used to provide the illumination of the lighting arrangement.

By providing such an extended light source it will be appreciated that the light output is higher than that traditionally achievable. In such circumstances it is desirable to be able to control the output of the light. This may be achieved by using simple switching to change the output luminosity—for example using a dimmer switch. Alternatively different combinations of the individual lights could be selectively activated to change the overall output. Suitable configurations could include a high output with all lights on, a medium output with some top orientated lights left off or a low output with only some bottom orientated lights left on.

If the film 135 is used, then this is desirably located immediately adjacent to the light sources defining the wall of light. In front of the film, a diffuser screen 140 may be provided—the diffuser being provided to distribute the light generated more evenly so as to generate a substantially uniform incident light on the rear surface of the flame effect simulation arrangement.

The diffuser screen 140 separates the wall of light defined by the lighting arrangement 115 from a flame simulation arrangement 145. In the embodiment illustrated, the flame simulation arrangement comprises a plurality of flags 150 which are mounted within a frame 155, and are orientated to hang vertically down within the housing of the fire. The frame serves two purposes; firstly to maintain the flags in their desired orientation and secondly to provide for occlusion of certain portions of the light so as to generate dark patterns in the result image. The flags are of the type well known in the art and are typically loosely hung such that when air generated by a blower 160 located below their frame 155 is incident on the flags, that they will flutter—thereby simulating the flickering of flames in a real fire. The flags may be provided of all the same colour or of different colours. By extending the area of illumination behind the flame simulation arrangement so as to substantially overlap with the area defined by the flames it is possible to improve the overall aesthetic effect of a fire burning.

While it is preferable to use a flag arrangement to simulate flames other arrangements are possible. For example, a semi-transparent screen may be provided which is patterned to provide the effect of flames on the screen. By illuminating the screen from the rear using the wall of light it is possible to generate the effect of flames—the patterned surfaces will be more visible than those non-patterned, and if patterned appropriately will thereby defining a flame.

As shown in FIG. 2, once the rear internal workings used to generate the flame effect are assembled in their casing 105, the casing is then coupled to a front portion of the fire. A viewing screen 165 is presented in front of the flag assembly. Desirably a front portion of this screen is treated to be reflective whereas a rear portion—i.e. that portion adjacent to the flag assembly, provides a diffuse surface. A fuel effect arrangement 170, which is typically fabricated in a plastics material and moulded to simulate fuel element such as coal or wood is provided in front of the viewing screen 165 and in a lower portion of the fire. This projects forwardly of the flame effect simulation arrangement. A frame 175 is then used, in combination with the rear casing to define the outer surface of the assembled fire. Some fires also provide a front glass window 180 which ensures that the inner components of the fire are not easily accessible from outside—this it will be appreciated is an optional components.

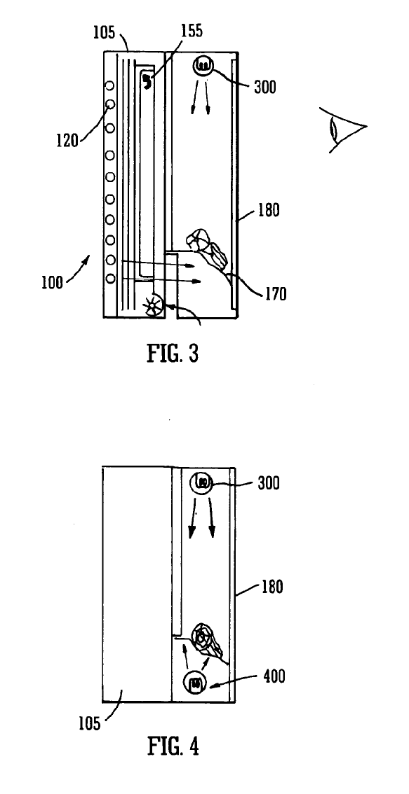

As shown in the sectional view of FIG. 3 an additional light source 300 may be provided in an upper portion of the fire to provide top illumination to a front portion of the fire. Light from the backlight lighting arrangement may be allowed to shine through to illuminate internally the fuel effect arrangement 170. If the flags overlap with the light guide, as shown in FIG. 3, it will be appreciate that any flapping of the flags under the influence of their blower may serve to generate a flicker effect within the fuel effect arrangement 170. It will be understood that the light guide may not be formed by a distinct physical part but may be realised by the enablement of light generated by the wall of light to simply pass forwardly and arranging the fuel effect arrangement suitably to take advantage of this light.

In an alternative arrangement, shown in FIG. 4, with the sectional view being only the front portion of the fire, the wall of light is not used to provide the internal illumination to the fuel effect arrangement 170, rather this is provided by an independent light source 400 provided in a lower portion of the fire underneath the fuel effect arrangement.

Use of light sources to generate a wall of light that is dimensioned to substantially overlap with the flame effect simulation arrangement is advantageous for a number of reasons. For example, the backlighting of the simulation arrangement is more constant than heretofore achievable using for example a bottom lit arrangement where a light source was provided in a lower portion of the fire and was used to light upwardly with the effect that upper portions of the flame effect were not illuminated as greatly as the lower portions. This also affected the ultimate height that could be provided for such flames. Other advantages include:

If the source of lamination is CCFL's or EL's, these operate at very cool temperatures and would not therefore contribute to heating effects within the fire. These are also provided as very thin light sources, approximately 5 mm meaning that the depth profile of the fire does not become too large. There would be no need for servicing as these technologies last for long periods. By effectively orientating the lights, it is possible to provide a very efficient use of light resources and by directing the light to specific areas, is possible reduce light leakage.

The brightness achievable with such sources is such that the floor reflections normally associated with a reflective viewing screen does not happen. Normally dotted patterns are printed onto the reflective surface to hide these reflections and this is not necessary using these technologies.

With regard to display advantages it will be appreciated that as the light is distributed across the entire flame effect arrangement, and the luminosity may be altered that the flame picture achievable is very bright.

The words comprises/comprising when used in this specification are to specify the presence of stated features, integers, steps or components but does not preclude the presence or addition of one or more other features, integers, steps, components or groups thereof.

1. An electric fire including a housing configured to support a vertically orientated flame effect simulation arrangement, the fire further including a lighting arrangement configured to provide a backlighting of the flame effect simulation arrangement, the lighting arrangement being provided in the housing along a plane substantially parallel to the flame effect simulation arrangement.

2. The fire as claimed in claim 1 wherein the lighting arrangement is provided having substantially the same dimensions as the flame effect simulation arrangement.

3. The fire as claimed in claim 1 wherein the dimensions of lighting arrangement substantially overlap with the dimensions with the flame effect simulation arrangement.

4. The fire as claimed in claim 1 wherein the lighting arrangement defines a wall of light which illuminates the flame effect simulation arrangement in a substantially uniform manner.

5. The fire as claimed in claim 1 wherein the lighting arrangement is provided by at least one cold cathode fluorescent lamp, CCFL, tube.

6. The fire as claimed in claim 6 comprising a plurality of CCFL tubes, the tubes being arranged one above the other.

7. The fire as claimed in claim 6 comprising a plurality of CCFL tubes, the tubes being arranged side by side relative to one another.

8. The fire as claimed in claim 1 wherein the lighting arrangement is provided by a plurality of LED's.

9. The fire as claimed in claim 1 wherein the lighting arrangement is provided by an electroluminescent screen.

10. The fire as claimed in claim 1 wherein the luminosity provided by the lighting arrangement is controllable.

11. The fire as claimed in claim 1 further including a diffuser provided between the lighting arrangement and the flame effect simulation arrangement.

12. The fire as claimed in claim 1 wherein the flame effect simulation arrangement is provided by a plurality of flags.

13. The fire as claimed in claim 12 wherein the flags are provided as a fabric mounted to a frame.

14. The fire as claimed in claim 13 wherein the flags are moveable under the influence of applied blown air.

15. The fire as claimed in claim 13 including a blower, mounted in a lower portion of the fire, the blower being configure to generate and direct air upwardly to act upon the flags.

16. The fire as claimed in claim 1 including a fuel effect arrangement.

17. The fire as claimed in claim 16 wherein the fuel effect arrangement is projects forwardly of the flame effect simulation arrangement.

18. The fire as claimed in claim 16 wherein the lighting arrangement is also configured to internally illuminate the fuel effect arrangement.

19. (canceled)
